(19) United States
(12) Patent Application Publication
(10) Pub. No.: US 2023/0269668 A1
(43) Pub. Date: Aug. 24, 2023

(54) RESOURCE CONTROL

(71) Applicant: Nokia Technologies Oy, Espoo (FI)

(72) Inventor: Chulhong MIN, Cambridge (GB)

(21) Appl. No.: 18/006,611

(22) PCT Filed: Jul. 20, 2021
(86) PCT No.: PCT/FI2021/050536

§ 371 Date: Jan. 24, 2023

(30) Foreign Application Priority Data
Jul. 30, 2020 (GB) 2011855.0

(51) Int. Cl. H04W 52/02; H04L 67/1008; H04L 41/0803

(52) U.S. Cl. CPC H04W 52/0261; H04L 67/1008; H04L 41/0803

(57) ABSTRACT

An apparatus comprising means for: receiving one or more monitoring requests; determining one or more device actions to be performed to fulfill the received one or more monitoring requests; determining one or more device configurations for the one or more monitoring requests, wherein determining one or more device configurations comprises assigning the one or more determined device actions to one or more devices from a plurality of available devices; determining a device resource usage rate for the determined one or more device configurations; and determining a schedule of device configuration usage 10 based, at least in part, on the determined device resource usage rate or rates and available device resources.

### TECHNOLOGICAL FIELD

Embodiments of the present disclosure relate to resource control. Some relate to resource control in a network of devices comprising one or more sensors.

### BACKGROUND

A network of devices can be used for monitoring purposes. For example, a network of devices can be used for human monitoring or sensing purposes.

In some circumstances it may be desirable to improve resource control amongst a plurality of devices.

### BRIEF SUMMARY

According to various, but not necessarily all, embodiments there is provided examples as claimed in the appended claims.

According to various, but not necessarily all, embodiments there is provided an apparatus comprising means for:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate or rates and available device resources.

In examples, the device resource usage rate comprises an energy usage rate and the available device resources comprises an amount of energy available to the devices of the one or more device configurations.

In examples, receiving one or more monitoring requests comprises receiving a plurality of monitoring requests.

In examples, determining one or more device actions comprises determining one or more sensing actions and/or determining one or more processing actions to be performed.

In examples, determining one or more device configurations comprises determining one or more available sensors configured for use in fulfilling the one or more monitoring requests.

In examples, determining a schedule of device configuration usage comprises at least one of:
optimizing use of available device resources;
balancing running times for the received at least one monitoring request; and
prioritizing a running time of at least one received monitoring request.

In examples, the means are configured to control one or more device of a device configuration to fulfill a received monitoring request at a scheduled time, based, at least in part, on the determined schedule of device configuration usage.

In examples, the means are configured to:
determine a change in the plurality of available devices; and
update the schedule of device configuration usage based, at least in part, on the determined change in the plurality of available devices.

In examples, the change in the plurality of available devices comprises addition of at least one available sensor and/or removal of at least one available sensor.

In examples, the means are configured to:
determine a change in the available device resources; and
update the schedule of device configuration usage based, at least in part, on the determined change in the available device resources.

In examples, the change in the available device resources comprises at least one of the available devices being charged.

In examples, the schedule of device configuration usage comprises a scheduled change from a first device configuration for a monitoring request to a second, different device configuration for the monitoring request.

In examples, the means are configured to:
determine that at least one of the monitoring requests is removed; and
update the schedule of device configuration usage based, at least in part, on the remaining monitoring request or requests.

In examples, determining a schedule of device configuration usage comprises determining a degree of competition for available devices and/or sensors of the available devices for the determined device configurations; and
determining the schedule of device configuration usage based, at least in part, on the determined degree of competition.

In examples, determining a degree of competition for available devices and/or sensors of available devices comprises determining the number of device configurations that involve the available devices and/or the sensors of available devices, and determining the amount of energy available to the available devices and/or sensors of available devices.

In examples, at least some of the plurality of available devices are interrelated and/or interdependent.

In examples, the means comprises
at least one processor; and
at least one memory including computer program code, the at least one memory and computer program code configured to, with the at least one processor, cause the performance of the apparatus.

According to various, but not necessarily all, embodiments there is provided an apparatus comprising:
at least one processor; and
at least one memory including computer program code, the at least one memory and computer program code configured to, with the at least one processor, cause performance of, at least:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate or rates and available device resources.

According to various, but not necessarily all, embodiments there is provided a method comprising:
receiving one or more monitoring requests;
   determining one or more device actions to be performed to fulfill the received one or more monitoring requests;
   determining one or more device configurations for the one or more monitoring requests, wherein determining one or more device configurations comprises assigning the one or more determined device actions to one or more devices from a plurality of available devices;
   determining a device resource usage rate for the determined one or more device configurations; and
   determining a schedule of device configuration usage based, at least in part, on the determined device resource usage rate or rates and available device resources.

In examples, the device resource usage rate comprises an energy usage rate and the available device resources comprises an amount of energy available to the devices of the one or more device configurations.

In examples, receiving one or more monitoring requests comprises receiving a plurality of monitoring requests.

In examples, determining one or more device actions comprises determining one or more sensing actions and/or determining one or more processing actions to be performed.

In examples, determining one or more device configurations comprises determining one or more available sensors configured for use in fulfilling the one or more monitoring requests.

In examples, determining a schedule of device configuration usage comprises at least one of:
optimizing use of available device resources;
balancing running times for the received at least one monitoring request; and
prioritizing a running time of at least one received monitoring request.

In examples, the method comprises controlling one or more device of a device configuration to fulfill a received monitoring request at a scheduled time, based, at least in part, on the determined schedule of device configuration usage.

In examples, the method comprises:
determining a change in the plurality of available devices; and
updating the schedule of device configuration usage based, at least in part, on the determined change in the plurality of available devices.

In examples, the change in the plurality of available devices comprises addition of at least one available sensor and/or removal of at least one available sensor.

In examples, the method comprises:
determining a change in the available device resources; and
updating the schedule of device configuration usage based, at least in part, on the determined change in the available device resources.

In examples, the change in the available device resources comprises at least one of the available devices being charged.

In examples, the schedule of device configuration usage comprises a scheduled change from a first device configuration for a monitoring request to a second, different device configuration for the monitoring request.

In examples, the method comprises:
determining that at least one of the monitoring requests is removed; and
updating the schedule of device configuration usage based, at least in part, on the remaining monitoring request or requests.

In examples, determining a schedule of device configuration usage comprises determining a degree of competition for available devices and/or sensors of the available devices for the determined device configurations; and
determining the schedule of device configuration usage based, at least in part, on the determined degree of competition.

In examples, determining a degree of competition for available devices and/or sensors of available devices comprises determining the number of device configurations that involve the available devices and/or the sensors of available devices, and determining the amount of energy available to the available devices and/or sensors of available devices.

In examples, at least some of the plurality of available devices are interrelated and/or interdependent.

According to various, but not necessarily all, embodiments there is provided an apparatus comprising means for performing and/or for causing performance of at least a part of a method as described herein.

According to various, but not necessarily all, embodiments there is provided a computer program comprising instructions for causing an apparatus to perform at least the following:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate and available device resources.

In an example an apparatus comprising means for:
sending, by the apparatus, a request to an entity;
   wherein the request requests determining of one or more device actions to be performed to fulfill one or more monitoring requests; one or more device configurations for the one or more monitoring requests, wherein determining of the one or more device configurations comprises assigning the one or more determined device actions to one or more devices from a plurality of available devices; a device resource usage rate for the determined one or more device configurations; and a schedule of device configuration usage based, at least in part, on the determined device resource usage rate or rates and available device resources,
receiving, by the apparatus, in response to the request from the entity the determined schedule of the device configuration usage based, at least in part, on the determined device resource usage rate or rates and the available device resources; and
performing the determined one or more device actions.

According to various, but not necessarily all, embodiments there is provided a computer program comprising instructions for causing an apparatus to perform at least a part of a method as described herein.

The description of a function and/or action should additionally be considered to also disclose any means suitable for performing that function and/or action.

### BRIEF DESCRIPTION

Some examples will now be described with reference to the accompanying drawings in which:

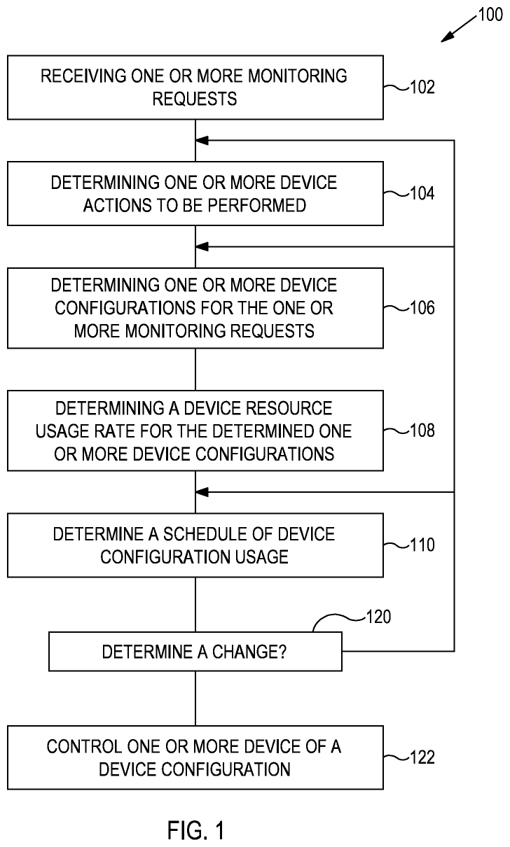

FIG. 1 shows an example of the subject-matter described herein;

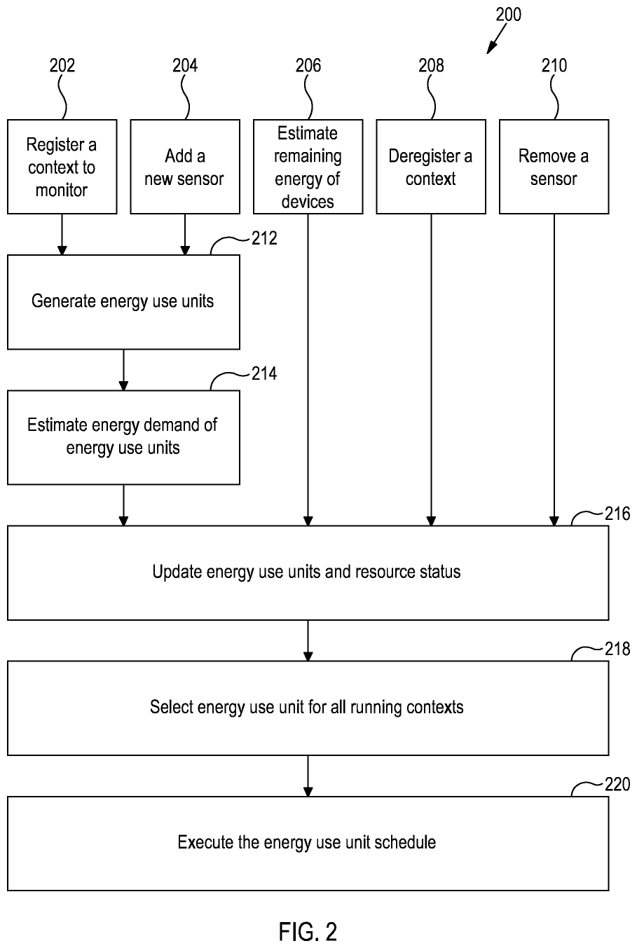

FIG. 2 shows an example of the subject-matter described herein;

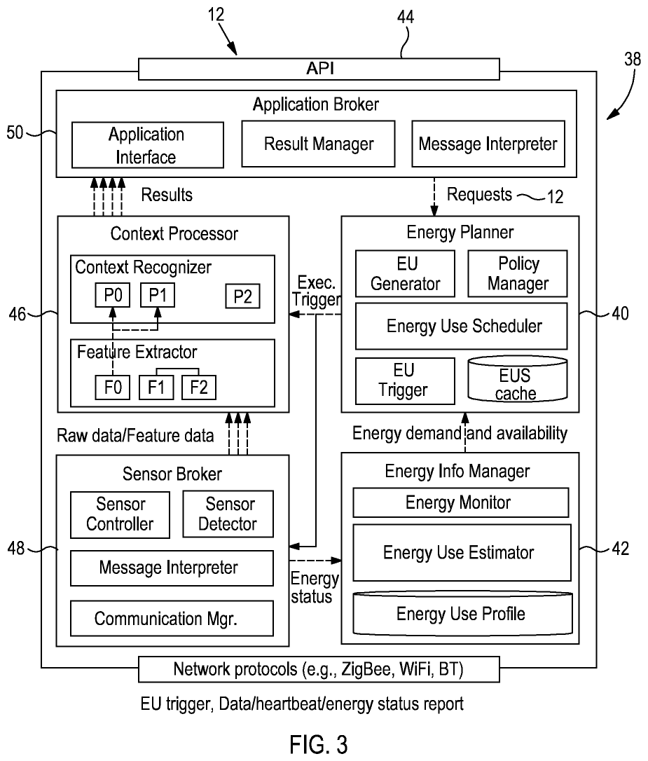

FIG. 3 shows an example of the subject-matter described herein;

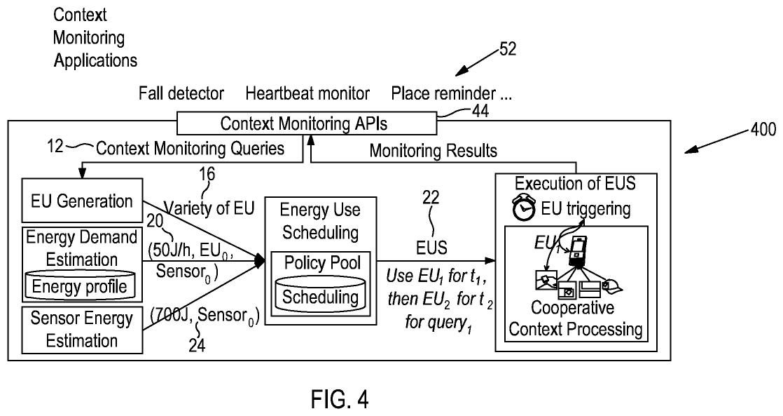

FIG. 4 shows an example of the subject-matter described herein;

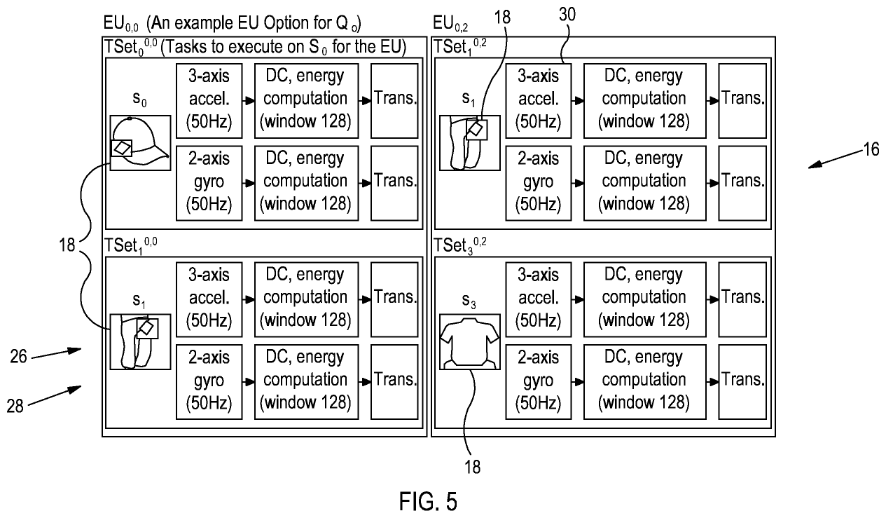

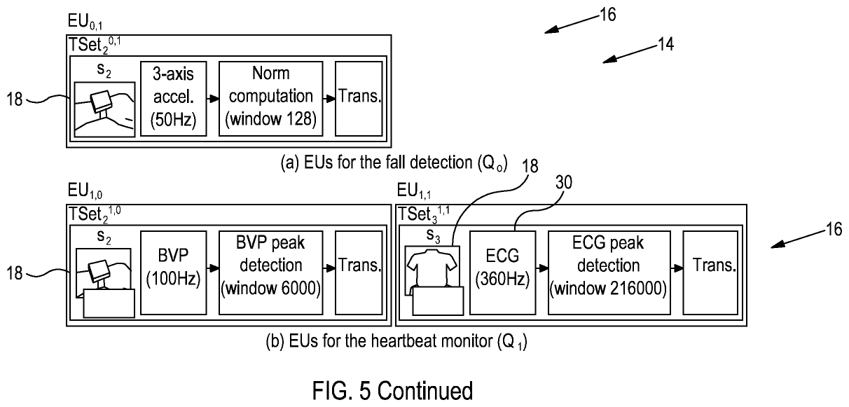

FIG. 5 shows an example of the subject-matter described herein;

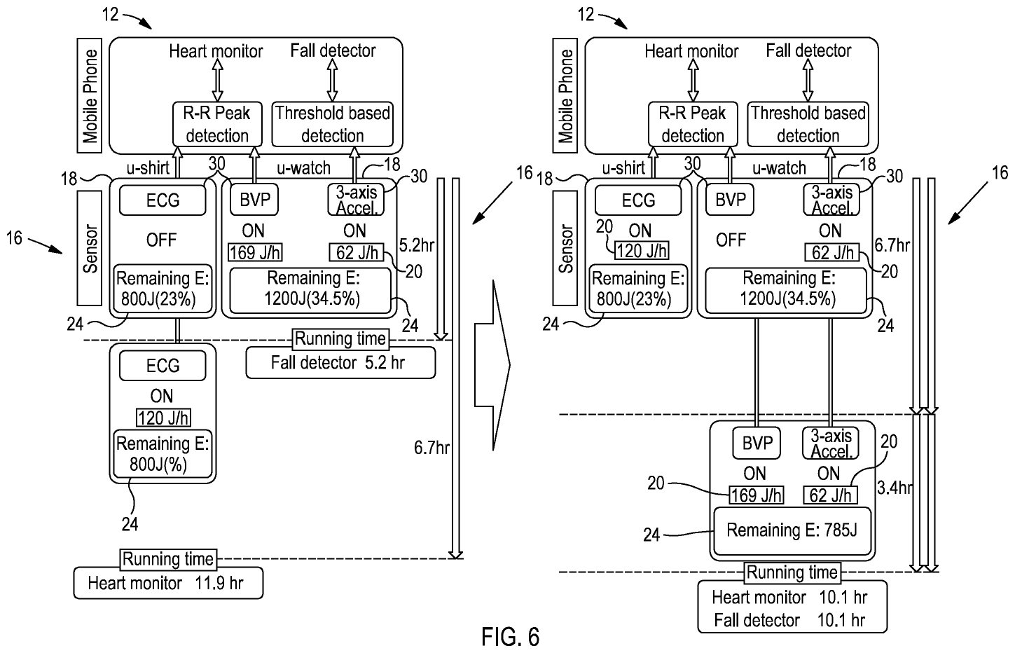

FIG. 6 shows an example of the subject-matter described herein;

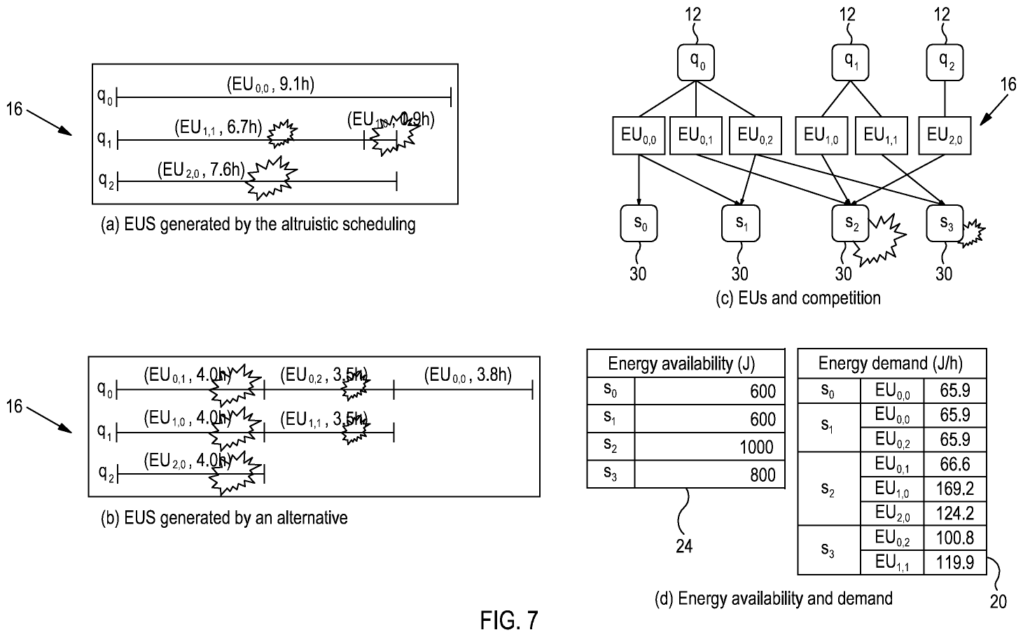

FIG. 7 shows an example of the subject-matter described herein;

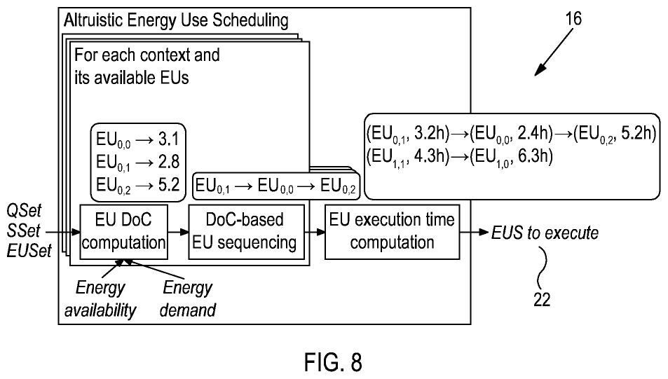

FIG. 8 shows an example of the subject-matter described herein;

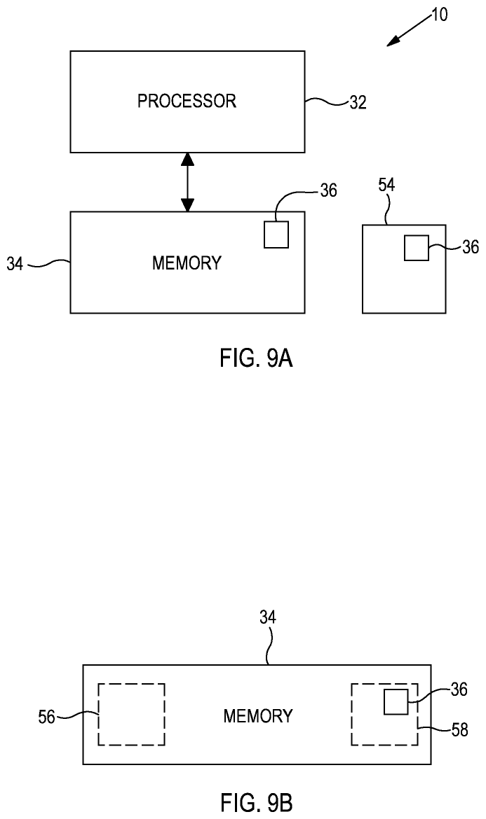

FIG. 9A shows an example of the subject-matter described herein; and

FIG. 9B shows an example of the subject-matter described herein.

### DETAILED DESCRIPTION

FIG. 1 illustrates an example of a method 100.

In examples, the method 100 can be performed by any suitable apparatus 10. For example, any suitable apparatus 10 comprising means for performing the method 100 and/or means configured to perform the method 100.

In examples, the method 100 can be performed by an apparatus 10 as described in relation to, at least, FIG. 9A and/or FIG. 9B.

In some examples, the method 100 can be performed by an apparatus 10 as described in relation to, at least, FIG. 9A and/or FIG. 9B, in any suitable electronic device.

In examples, the method 100 can be considered a method of resource control and/or resource management and/or resource balancing in a plurality of devices.

One or more of the features discussed in relation to FIG. 1 can be found in one or more of the other figures.

At block 102, the method 100 comprises receiving one or more monitoring requests 12.

In examples, any suitable method for receiving one or more monitoring requests 12 can be used.

For example, receiving one or monitoring requests 12 can comprise receiving one or more signals comprising information including and/or configured to indicate the one or more monitoring requests 12.

In examples, a monitoring request 12 can be considered a request received from one or more applications for use of one or more device resources to perform one or more tasks or actions, such as one or more monitoring and/or sensing tasks or actions.

In examples, a monitoring request 12 can be considered a context monitoring request received from a context monitoring application. In examples, context refers to high level information determined and/or inferred from sensor data from any suitable sensor or sensors such as one or more accelerometers, one or more Sp02 sensors, one or more gyros, one or more temperature sensors, one or more humidity sensors, one or more proximity sensors, one or more motion sensors, one or more microphones, one or more cameras and so on.

In examples, the one or more monitoring requests 12 can be received from any suitable application or applications. For example, a heartrate monitor, a fall detector, a location-based reminder, a calorie monitor, a sleep pattern detector, temperature monitoring-based heating control, air quality monitoring-based window control, humidity monitoring-based water control, motion-based light control physical activity monitoring and so on.

In examples, the one or more monitoring requests 12 can be received via one or more application program interfaces (APIs) which, in some examples, can be considered context monitoring APIs.

In examples, an application interface can be used to interact with the one or more context monitoring applications. See, for example, FIG. 3.

The one or more monitoring requests 12 can have any suitable form and/or format. For example, the one or more monitoring requests 12 can be formatted for and/or configured for use with one or more APIs.

In examples, receiving one or more monitoring requests 12 comprises receiving a plurality of monitoring requests 12. For example, receiving one or more monitoring requests 12 can comprise receiving a plurality of monitoring requests 12 from a plurality of applications.

In examples, a device may have a plurality of applications which control usage rates and/or communications therebetween.

In examples, a monitoring request 12 can be considered one or more monitoring messages.

In some examples, monitoring requests 12 can be received from any suitable source. For example, one or more monitoring requests 12 can be received from a device/devices performing method 100 and/or one or more external devices.

At block 104, the method 100 comprises determining one or more device actions 14 to be performed to fulfill the received one or more monitoring requests 12.

Any suitable method for determining one or more device actions to be performed to fulfill the one or more monitoring requests 12 can be used.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

Accordingly, in examples, determining one or more device actions 14 to be performed to fulfill the received one or more monitoring requests 12 can comprise retrieving information from a memory 34 and/or analyzing the one or more monitoring requests 12 to determine one or more device actions 14 to be performed to fulfill the one or more monitoring requests 12.

In examples, one or more device actions 14 to be performed to fulfill a monitoring request 12 can be considered a set of device actions 14 and/or a processing alternative and/or an inference pipeline and so on for the monitoring request, such as, for example, for fall detection or heartrate monitoring.

In examples, the one or more device actions 14 can be considered one or more actions to be performed at one or more devices to fulfill a monitoring request 12.

In examples, one or more of the one or more device actions 14 can be configured to be performed in parallel and/or in series.

In some examples, determining one or more device actions 14 comprises determining one or more sensing actions 26 and/or determining one or more processing actions 28 to be performed.

Accordingly, in examples, determining one or more device actions 14 to be performed can comprise determining information to be obtained and/or determining processing of information to be carried out to fulfill one or more received monitoring requests 12.

In examples, a monitoring request 12 can have multiple sets of device actions (and/or processing alternatives and/or inference pipelines) suitable for and/or configured to fulfill the monitoring request 12. In examples, these can be considered alternative and/or substitutable sets of device actions and/or processing alternatives and/or inference pipelines for a monitoring request 12.

For example, a context of determining that a user is running can, in examples, be determined with frequency-domain features from acceleration data and a decision tree classifier.

Alternatively, a running context can be determined with time-domain statistical features and a Naïve Bayes classifier.

Similarly, contexts such as fall determination and heartrate monitor can have alternative device action sets and/or processing alternatives and/or inference pipelines. See, for example, FIG. 5.

At block 106 the method 100 comprises determining one or more device configurations 16 for the one or more monitoring requests 12, wherein determining one or more device configurations 16 comprises assigning the one or more determined device actions 14 to one or more devices 18 from a plurality of available devices 18.

Any suitable method for determining one or more device configurations 16 can be used.

In examples, determining one or more device configurations 16 can be considered assigning the determined sets of device actions and/or processing alternatives and/or inference pipelines for the received monitoring request(s) 12 to one or more available devices 18.

In examples, different device actions 14 in a set of one or more device actions/processing alternatives/inference pipelines can be assigned to a device 18 or a plurality of different devices 18.

In examples, a set of one or more device actions and/or inference pipeline and/or processing alternative can have one or more associated device configurations 16. In examples, a device action set/inference pipeline/processing alternative can have a plurality of associated device configurations 16.

A device configuration 16 can, in some examples, be considered an energy use unit (EU). In examples, a monitoring request 12 can have multiple alternative EUs.

Accordingly, in examples, a set of one or more device actions 14 and/or an inference pipeline and/or a processing alternative can be considered to represent a series of tasks for inferring “context” from “raw” sensor data and a device configuration 16 and/or EU can be considered to represent a configuration of the tasks of a monitoring request 12 across one or more available devices.

See, for example, FIGS. 5 and 6.

In examples, any suitable device 18 or devices 18 can be used. In some examples, one or more of the plurality of available devices 18 are wearable devices.

In some examples, at least some of the plurality of available devices 18 are configured in a network. Any suitable short, medium or long range network or network environment can be used. For example, spatially distributed devices in a 5G network can be used and/or an internet of things environment IoT can be used and so on.

In some examples, at least some of the plurality of available devices 18 form a personal area network of a user.

In examples, the network can comprise and/or be any suitable network using any suitable network protocol such as ZigBee, WiFi, Bluetooth, 5G and so on.

In examples, at least some of the plurality of devices 18 can be proximate to a user. For example, at least some of the plurality of devices 18 can be attached to and/or carried by and/or worn by the user.

In some examples, at least some of the devices can be spatially distributed across a wider area using, for example, 5G network.

In examples, a device 18 can be considered available if it is available for use in fulfilling one or more monitoring requests 12. For example, a device 18 can be considered available if information can be transferred between the apparatus 10 and the device 18.

In examples, determining one or more device configurations 16 comprises determining one or more available sensors 30 configured for use in fulfilling the one or more monitoring requests 12. In examples devices 18 and/or sensors 30 can be considered sensor nodes.

Accordingly, in examples, determining one or more device configurations 16 can comprise determining sensors 30 that are available amongst the plurality of available devices 18.

In examples, at least some of the plurality of available devices 18 and/or sensors 30 are or can be considered to be interrelated and/or interdependent.

In examples, a plurality of devices 18 and/or sensors can be considered interdependent in a scenario where an availability of a monitoring application is determined by a set of devices 18/sensors 30 which, in turn, determine another monitoring application's availability.

In examples, a plurality of devices 18 can be considered interrelated if use of one device 18 affects, in some way, use of another device 18.

At block 108, the method 100 comprises determining a device resource usage rate 20 for the determined one or more device configurations 16.

Any suitable method for determining a device resource usage rate 20 for the determined one or more device configurations 16 can be used.

In examples, device resource usage rate 20 can be determined in any suitable form, for example as an amount per time unit, such as per second, and/or as a proportion of an overall capacity of a system, such as a system of available devices 18.

In examples, a device resource usage rate 20 for a device configuration 16 can comprise a mixture of rate(s) as a function of time and as a proportion of system capacity.

In some examples, determining a device resource usage rate 20 can comprise determining a resource usage rate for the device action(s) 14 in a device action set/inference pipeline/processing alternative on the respective device(s) 18 and summing the total usage rate across the device configuration 16.

In examples, the device resource usage rate 20 comprises an energy usage rate and determining a device resource usage rate 20 for a device configuration 16 comprises determining an energy usage rate for the device actions 14 of the assigned devices 18.

For example, the energy usage rate can be in the form of the amount of energy used per second, such as millijoules per second.

In examples, the device may send a request to an entity, which can be another device or computer, for example.

In examples the device may receive a response from an entity which can be another device or computer, for example.

In examples the response may comprise at least one determined schedule of the device configuration usage based, at least in part, on the determined device resource usage rate or rates and the available device resources.

In the examples device may perform the determined one or more device actions according to at least one determined schedule of the device configuration usage based, at least in part, on the determined device resource usage rate or rates and the available device resources.

An example of determining of a plurality of device configurations 16 with associated device resource usage rate 20 can be as follows:
a. Preparing for multiple, substitutable inference pipelines, for example, for “fall detection”,
   a. (1) [sensing IMU on smartwatch]+[FFT]+[Decision tree],
   b. (2) [sensing IMU on smartphone]+[statistical features]+[SVM]
   c. an inference pipeline consists of multiple sensing/processing tasks
b. Generating EUs by assigning tasks into possible devices, for example,
   a. (1-1) [sensing IMU on smartwatch]+[FFT] on “smartwatch” and [Decision tree] on “smartphone”
   b. (1-2) [sensing IMU on smartwatch] on “smartwatch” and [FFT]+[Decision tree] on “smartphone”
   c. (2-1) [sensing IMU on smartphone]+[statistic features]+[SVM] on “smartphone”
c. Assigning the energy information to the tasks, for example,
   a. (1-1) [sensing IMU on smartwatch]+[FFT] on “smartwatch+20 mJ/s” and [Decision tree] on “smartphone+10 mJ/s”
   b. (1-2) [sensing IMU on smartwatch] on “smartwatch+10 mJ/s” and [FFT]+[Decision tree] on “smartphone+20 mJ/s”
   c. (2-1) [sensing IMU on smartphone]+[statistic features]+[SVM] on “smartphone+50 mJ/s”

At block 110, the method 100 comprises determining a schedule of device configuration usage 22, based, at least in part, on the determined device resource usage rate or rates 20 and available device resourced 24.

Any suitable method for determining a schedule of device configuration usage 22 can be used.

For example, a schedule of device configuration usage 22 can be determined given any suitable goal or goals and/or target or targets and/or limit or limits and/or aim or aims and/or restriction or restrictions and so on.

For example, a schedule of device configuration usage 22 can be determined to balance resources of the available devices 18 and/or to balance running times of one or more context monitoring applications and/or to ensure that device resource usage remains lower than a capacity of a system and/or to optimize device resource usage in a system.

In examples, the device resource usage rate 20 comprises an energy usage rate and the available device resources 24 comprises an amount of energy available to the devices 18 of the one or more device configurations 16.

Accordingly, in such examples, determining a device resource usage rate 20 for the determined one or more device configurations 16 comprises determining an energy usage rate for the determined one or more device configurations 16.

Similarly, in such examples, determining a schedule of device configuration usage 22 based, at least in part, on the determined device resource usage rate or rates 20 and available device resources 24 comprises determining a schedule of device configuration usage 22 based, at least in part, on the determined energy resource usage rate or rates and available energy resources.

In examples, determining a schedule of device configuration usage 22 comprises at least one of:
optimizing use of available device resources;
balancing running times for the received at least one monitoring request 12; and
prioritizing a running time of at least one received monitoring request 12.

For example, a schedule of device configuration usage 22 can be determined to allow some or all of the received monitoring requests 12 to run for as long as possible.

Alternatively, a schedule of device configuration usage 22 can be determined that allows a monitoring request 12, such as a fall detector, to run for as long as possible.

In some examples, the schedule of device configuration usage 22 comprises a scheduled change from a first device configuration 16 for a monitoring request 12 to a second, different device configuration 16 for the monitoring request 12.

That is, in examples, a monitoring request 12 can be fulfilled, for a period of time, by a first device configuration 16 and, after the first period of time, continue to be fulfilled by a second, different device configuration 16. See, for example, FIG. 6.

However, in general, any suitable schedule of device configuration usage 22 can be used.

In examples, determining a schedule of device configuration usage comprises determining a degree of competition for available devices 18 and/or sensors 30 of the available devices 18 for the determined device configuration 16; and
determining the schedule of device configuration usage 22 based, at least in part, on the determined degree of competition.

For example, monitoring requests 12 with diverse device configuration options and/or abundant energy resources can be scheduled to yield competitive resources to other monitoring requests with fewer device configuration options and/or scarce energy resources.

In some examples, determining a degree of competition for available devices 18 and/or sensors 30 of available devices 18 comprises determining the number of device configurations 16 that involve the available devices 18 and/or the sensors 30 of available devices 18, and determining the amount of energy available to the available devices 18 and/or sensors 30 of available devices 18.

See, for example, FIGS. 7 and 8.

Consequently, FIG. 1 illustrates a method 100 comprising:
receiving one or more monitoring requests 12;
determining one or more device actions 14 to be performed to fulfill the received one or more monitoring requests 12;
determining one or more device configurations 16 for the one or more monitoring requests 12, wherein determining one or more device configurations 16 comprises assigning the one or more determined device actions 14 to one or more devices 18 from a plurality of available devices 18;
determining a device resource usage rate 20 for the determined one or more device configurations 16; and
determining a schedule of device configuration usage 22 based, at least in part, on the determined device resource usage rate or rates 20 and available device resources 24.

In some examples, the method 100 can comprise determining available device resources 24.

In examples, the following can apply to the method 100 and/or method(s) described herein, such as the method 200 of FIG. 2:
A set of received monitoring requests, QSet={qᵢ|qᵢ is a received monitoring request 12/registered context monitoring query}
A set of available sensors, SSet={(sₖ, rₖ)|sₖ is an available sensor 30 and rₖ is its remaining energy}.

Then, the set of device configurations 16 or EUs, EUSet, can be defined as follows:
EUSet={EU_{i,j}|EU_{i,j} is the jth set of device actions/inference pipeline/processing alternative for qᵢ}, where
EU_{i,j}={(sₖ, TSetₖ^{i,j}, dₖ^{i,j})|TSetₖ^{i,j} is a set of tasks executed/to be executed on sₖ for EU_{i,j}, and dₖ^{i,j} is its energy demand}.

Given Qset and Sset as inputs, a schedule of device configuration usage (EUS) 22 can be determined to meet one or more goals under resource constraints, such as energy constraints, of the system.

In examples, EUS={EUSeq₁|EUSeq₁ is a sequence of (EU_{i,m}, t_{i,m}) pairs over a timeline representing the execution sequence of EU_{i,m}'s for a query qᵢ}

In examples, the pair (EU_{i,m}, t_{i,m}) represents the allocation of EU_{i,m} for the time duration t_{i,m} for qᵢ.

In some examples, for the received one or more monitoring requests 12, a sequence of EUs is assigned until the battery of the associated device(s) 18 is depleted.

A simple example is, if a query, q₁, has two EUs (EU_{1,1}, EU_{1,2}), which use a smartphone and smartwatch, respectively, we can assign the sequence for q₁, either (EU_{1,1}→EU_{1,2}) or (EU_{1,2}→EU_{1,1}).
In examples, the energy constraint is Σ_{i,m}(dₖ^{i,m}×t_{i,m})≤rₖ for all sₖ

Here, the energy constraint refers to the situation that, for a sensor 30, the energy consumed by a sequence of associated EUs for all queries should be less than the remaining energy of the sensor 30; the energy cost is calculated by multiplying the energy consuming rate and the duration.

In some examples, an optimization goal is set to equally balance the running time of all received monitoring requests 12, under the assumption that every context monitoring request should be continuously supported and is equally important.

In examples, such an optimization goal can be considered to be to minimize the standard deviation of the running times of all monitoring requests 12 in QSet, which can be defined as follows:

Minimize std(RT), where RT={rtᵢ|rtᵢ=Σⱼt_{i,j}, which denotes the running time of qᵢ}.

Running time can, in examples, be considered to be the minimum battery life among the devices 18 or sensors 30 involved in the request, where the battery life of a device 18 or sensor 30 can be computed by dividing its battery capacity by its expected energy cost.

At block 120, the method comprises determining if a change has occurred.

In examples, the method 100 comprises determining if a change has occurred in relation to any of the preceding blocks 102, 104, 106, 108 and/or 110.

Accordingly, in examples, the method 100 can comprise determining if a change has occurred in the one or more monitoring requests 12, and/or in the one or more available devices 18 and/or sensors 30, and/or in the device resources 24.

In examples, on-line and/or real-time usage data can be received and/or obtained and a determination made whether or not to update the schedule 22 based, at least in part, on the data.

For example, if no substantial change is determined, for example within an acceptable threshold then no update is performed.

In examples, the method 100 can comprise determining whether or not to transmit or cause transmission of an update, for example updated device configuration(s), to one or more devices 18 and/or one or more applications.

In examples, the method 100 comprises determining a change in the plurality of available devices 18; and updating the schedule of device configuration usage 22 based, at least in part, on the determined change in the plurality of available devices 18.

In examples, the change in the plurality of available devices 18 comprises addition of at least one available sensor 30 and/or removal of at least one available sensor 30.

In some examples, the change in the plurality of available devices 18 comprises addition of at least one device 18 and/or removal of at least one device 18.

In the example of FIG. 1, the method 100 can, in such examples, return from block 120 to block 106, as indicated by the arrow located between blocks 104 and 106, and the method 100 updated based, at least in part, on the determined change.

Accordingly, in such examples, the method 100 returning to blocks 106, 108 and 110 can be considered to update the respective actions.

In examples, the method 100 comprises determining a change in the available device resources 24; and
updating the schedule of device configuration usage 22 based, at least in part, on the determining change in the available device resources 24.

In some examples, the change in the available device resources comprises determining a change in the amount of energy available at one or more of the available devices 18.

In some examples, the change in the available device resources comprises at least one of the available devices 18 being charged.

In such examples, the method 100 can return from block 120 to block 110 as indicated by the arrow located between blocks 108 and 110, and the method 100 updated based, at least in part, on the determined change.

Accordingly, in such examples, the method 100 returning to block 110 can be considered to update the respective action.

In some examples, the method 100 comprises determining that at least one of the monitoring requests 12 is removed; and updating the schedule of device configuration usage 22 based, at least in part, on the remaining monitoring request 12 or requests 12.

For example, a plurality of monitoring requests 12 can be received and a schedule of device configuration usage 22 determined according to the method 100. Subsequently, one or more of the monitoring requests 12 can be removed and the schedule of device configuration usage 110 updated accordingly.

In the example of FIG. 1, the method 100 can, in such examples, return from block 120 to block 106, as indicated by the arrow located between blocks 104 and 106, and the method 100 updated based, at least in part, on the determined change.

Accordingly, in such examples, the method 100 returning to blocks 106, 108 and 110 can be considered to update the respective actions.

In some examples, one or more new monitoring requests 12 can be received. That is, in examples, the determined change can be the addition of a monitoring request 12.

In such examples, the method 100 can return, from block 120, to block 104 as indicated by the arrow between blocks 102 and 104, and the method 100 updated based, at least in part, on the determined change.

In such examples the method 100 returning to blocks 104, 106, 108 and 110 can be considered to update the respective actions.

Accordingly, in examples, the method 100 is adaptive to changes in monitoring request(s) 12, device(s), and/or device resources 24.

In examples, determining a change at block 120 can be performed in any suitable way. For example, checking for a change can be performed according to a schedule.

In examples, determining a change can be considered an update event. For example, receiving one or more new monitoring requests 12 and/or removal of one or more monitoring requests 12 can be considered an update event.

Additionally, or alternatively, addition and/or removal of one or more devices 18 and/or sensors 30 can be considered an update event.

Additionally, or alternatively, a change in device resources 24, for example an unexpected loss of energy at a device 18 and/or sensor 30 and/or charging of one or more devices 18 and/or sensors 30 can be considered an update event.

In examples, the method 100 can be considered to comprise evaluating an update event and determining if an update is to be made based, at least in part, on the update event. In examples, an update can comprise at least one of the following: Discard and/or cancel update event, if it is determined that changes caused, at least in part by the update event, are insignificant, for example do not exceed a change threshold.

Update the schedule of device configuration usage 22 and update device control and/or sensor control accordingly.

Update the schedule of device configuration usage 22 without updating device control and/or sensor control when changes to schedule are insignificant. For example, when changes in the schedule of device configuration usage 22 is less than a predetermined time value.

In examples any suitable predetermined time value can be used, for example less than 10 minute, less than 7 minutes, less than 5 minutes, less than 3 minutes, less than 1 minute and so on.

In examples, changes to the schedule of device configuration usage 22 can be considered insignificant when activity of one or more devices 18 and/or sensors 30 is to be terminated within a predetermined time value, according to the previous schedule of device configuration usage 22.

Any suitable predetermined time value can be used, for example within 10 minutes, within 7 minutes, within 5 minutes, within 3 minutes, within 1 minute and so on.

Immediate change of the schedule of device configuration usage 22 and consequential update to device 18 and/or sensor 30 control. For example, if it is determined that one or more devices 18 and/or sensors 30 have failed, an alternative, working device configuration 16 can be implemented.

In examples, evaluating an update event comprises checking one or more predefined thresholds associated with the update event. For example, a predefined threshold for energy loss in relation to an device resource update event.

At block 122, the method 100 comprises controlling one or more device 18 of a device configuration 16 to fulfill a received monitoring request 12 at a scheduled time, based, at least in part, on the determined schedule of device configuration usage 22.

Any suitable method for controlling one or more device 18 of a device configuration 16 to fulfill a received monitoring request 12 can be used.

For example, controlling one or more device 18 can comprise causing transmission and/or transmitting one or more signals comprising information.

In some examples, one or more control messages can be transmitted/caused to be transmitted to one or more of the devices 18 of a device configuration 16.

Examples of the disclosure are advantageous. For example, examples of the disclosure provide for appropriate control and/or management of resources, such as energy resources, of a plurality of devices to, for example, balance running times of context monitoring applications.

Additionally, or alternatively, examples of the disclosure provide for separate applications to simply register one or more requests without concerning themselves about resource management and/or control.

This, for example, allows application developers to be freed from low level resource, such as energy, management issues such as energy availability monitoring and demand profiling.

Examples of the disclosure prepare and utilize multiple alternative methods for a high level context, exploiting different sensor combinations, sensing modalities, sample rate and network interfaces.

Examples of the disclosure can prevent injudicious use of energy leading to irrevocable energy drains preventing certain desired user functionality.

FIG. 2 illustrates an example of a method 200.

In examples, the method 200 can be considered an alternative representation of the method 100.

In examples, the method 200 can be performed by any suitable apparatus 10. For example, any suitable apparatus 10 comprising means for performing the method 200 and/or means configured to perform the method 200.

In examples, the method 200 can be performed by an apparatus 10 as described in relation to, at least, FIG. 9A and/or FIG. 9B.

In some examples, the method 200 can be performed by an apparatus 10 as described in relation to, at least, FIG. 9A and/or FIG. 9B, in any suitable electronic device.

At block 202 of FIG. 2 the method 200 comprises registering a context to monitor. In examples, registering a context to monitor can be considered similar to or equivalent to receiving one or more monitoring requests 12.

Accordingly, in examples, block 202 can be as described in relation to block 102 of FIG. 1.

At block 212 the method 200 comprises generating energy use units (EUs).

In examples, generating energy use units (EUs) can be considered similar to or equivalent to determining one or more device configurations 16 for the one or more monitoring requests 12. Accordingly, in examples, block 212 of method 200 can be as described in relation to blocks 104 and 106 of method 100.

At block 214 the method 200 comprises estimating energy demand of energy use units.

In examples, estimating energy demand of energy use units 214 can be considered similar to or equivalent to determining a device resource usage rate 20 for the determined one or more device configurations 16.

Accordingly, in examples, block 214 of FIG. 2 can be as described in relation to block 108 of FIG. 1.

At block 216, the method 200 comprises updating energy use units and resource status.

In examples, block 216 can be considered similar to or equivalent to block 120 of FIG. 1 in which it is determined if a change is present.

In the example of FIG. 2 this can be seen by blocks 214, 206, 208 and 210 flowing into block 216.

At block 206, the method 200 comprises estimating remaining energy of devices 18.

Accordingly, in method 200, if at block 206 the estimated remaining energy of devices 18 changes the energy use units will be updated at block 216.

Similarly, at block 208, the method 200 comprises deregistering a context to monitor which will also update energy use units and resource status at block 216.

Block 210 comprises removal of a sensor 30 which will also cause update of energy use units and resource status at block 216.

Block 204 of method 200 comprises adding a new sensor 30.

As can be seen in the example of FIG. 2, with the addition of a new sensor, blocks 212 and 214 are also updated before the method 200 proceeds to block 216.

Accordingly, FIG. 2 illustrates updating of the device configurations 16 (EUs) under certain circumstances, similarly to the method 100 illustrated in the example of FIG. 1.

In examples, one or more monitoring requests 12 can comprise different types of request. In some examples, a monitoring request 12 can comprise data of current monitoring rate(s) of the one or more devices 18 and/or applications.

In examples, the data of the latest monitoring rate(s) can be used to update a current state of configurations to match and/or accommodate current device resource usage rate(s).

At block 218, the method 200 comprises selecting an energy use unit for all running contexts.

In examples, selecting an energy use unit for all running contexts can be considered similar to or equivalent to determining a schedule of device configuration usage 22.

Accordingly, block 218 can be as described in relation to block 110 of FIG. 1.

At block 220, the method 200 comprises executing the energy use unit schedule.

In examples, executing the energy use unit schedule can be considered similar to or equivalent to controlling one or more device of a device configuration 16.

Accordingly, in examples, block 220 can be as described in relation to block 122 of FIG. 1.

In examples, functionality of method 200 can be considered, at least partially, equivalent to the functionality of method 100.

FIG. 3. illustrates an example of a system architecture 38.

In examples, the system architecture 38 of the example of FIG. 3 can be a system architecture 38 configured to implement method 100 of FIG. 1 and/or method 200 of FIG. 2.

In examples, the architecture 38 can be implemented by any suitable apparatus 10. For example, any suitable apparatus 10 comprising means for implementing the architecture 38 and/or means configured to implement the architecture 38.

In examples, the architecture 38 can be implemented by an apparatus 10 as described in relation to, at least, FIG. 9A and/or FIG. 9B.

In examples, the architecture 38 can be considered a collaborative architecture 38 between a service gateway (for example, a personal device such as a smartphone) and multiple devices 18 comprising one or more sensors 30, which can be considered sensor devices 18.

In examples, a service gateway supports multiple concurrent applications, including one or more context monitoring applications.

A service gateway can also function as a sensor manager, which makes decisions for device resource control, which can, in some examples, include energy use control and/or balancing and/or equalization.

In some examples, sensor devices 18 execute a set of tasks for context monitoring as planned by, and in examples controlled by, the service gateway and provide resource information, such as energy information, for control in real time.

Discussed below are roles of system components and connections in perspective of energy use control.

In the illustrated example, the architecture comprises an energy planner 40, an energy information manager 42, a context processor 46, a sensor broker 48 and an application broker 50.

In examples, the energy planner 40 can be considered to provide at least part of means for performing the method 100 of FIG. 1 and/or the method 200 of FIG. 2.

In examples, the energy planner 40 in the service gateway makes decisions on energy use equalization and enforces the decisions.

In the illustrated example, the energy planner 40 includes three components that will be discussed further: an energy use unit (EU) generator, an energy use scheduler, and an EU trigger.

Once an energy use scheduling, which can be considered, in examples, a schedule of device configuration usage 22, is generated from a set of EUs, the EU trigger initiates execution of a proper EU at a designated time by sending one or more control messages to the context processors 46 in the service gateway and the corresponding sensor devices 18 via the sensor broker 48.

In examples, the energy use scheduler adjusts the energy use scheduling adaptively, reflecting changing situations such as dynamic sensor 30 join/leave and unexpected changes in energy availability reported from the sensor broker 48.

In some examples, such dynamic discovery of available devices 18 can be done with one or more wireless interfaces, for example, BLE, WiFi, and 5G. The discovery interval can be set by the system, for example, 10 seconds.

Also, the energy use scheduler adapts to a registration/deregistration event of an application reported from the application broker 50, for example, when there is a newly registered (or deregistered) application.

In examples, one or more energy estimators in the sensor device(s) 18 provide information of energy availability and the energy information manager in the service gateway provides information of energy demands to execute a set of tasks to the energy planner 40.

In the example of FIG. 3 the sensor broker 48 receives information of the energy availability of the devices 18 and passes the information to the energy information manager 42. The energy information manager provides the energy availability information and the energy demands for the tasks to the energy planner 40.

In examples, first, the energy estimator of a sensor device 18 estimates its remaining energy, and second, the energy use estimator of the energy information manager 42 provides energy demands to execute a set of tasks on a sensor node based, for example, on energy use profiles.

In examples, to execute an energy use unit as planned in the schedule 22, the architecture 38 employs the context processors both in the service gateway and sensor devices 18.

In examples, the context processors cooperatively process the tasks for context monitoring as specified in the schedule 22.

In examples, the context processor in a sensor device performs sensing tasks and feature extraction tasks.

In examples, the context processor 46 in the service gateway further processes the data from sensors 30, for example, complex feature extraction and context recognition tasks, and complete context monitoring.

If supported by the sensor hardware, a sensor can adopt the context recognition part also.

In examples, the application broker 50 interacts with applications through a set of APIs 44.

In some examples, API registerCMQ( ) can be used. In examples, registerCMQ( ) can allow applications to easily specify a context of interest as a form of query statement, which can be considered making a monitoring request 12.

For example, assume that a heartbeat monitor wants to know if the heart rate of a user is above 80 with 95% of accuracy. The query or monitoring request 12 can be specified as follows.
registerCMQ(“CONTEXT Heart rate>80
ACCURACY 95%
DURATION Always,
callback_for_result, callback_for_status”)

In examples, the application is notified of the query result in any suitable way. In some examples, the application is notified of the query result through the specified callback function, callback_for_result.

In some examples, applications can be notified of query status, for example, estimated running time, or no applicable energy use units, for example, through another callback function for status.

In examples the architecture 38 can comprise one or more additional elements not illustrated and/or have one or more elements arranged differently.

Additionally, or alternatively, one or more elements of the architecture 38 can be omitted or combined.

FIG. 4 illustrates an example of a resource management method.

In examples, the example of FIG. 4 can be similar to or the same as the example described in relation to FIG. 1 and/or FIG. 2.

In the example of FIG. 4, the device resource usage rate 20 comprises an energy usage rate and the available device resources comprises an amount of energy available to the devices 18 of the one or more device configuration 16.

The example of FIG. 4 shows an overview of an energy control/equalization method 400.

In the example of FIG. 4, to enable the equalization, the method 400 is equipped with several system primitives.

As a base, diverse energy use units are prepared for to support registered context monitoring queries, which can be considered received monitoring requests 12.

In some examples, also, the energy availability of sensors and the potential energy demands of energy use units for the generation of energy use schedule are identified.

Utilizing the primitives, the scheduling method 400 creates, in examples, a well balanced energy use scheduling 22 for received application requests.

In addition, in the illustrated example, newly joined or leaving sensors or applications are continuously detected, and the energy use schedule 22 adjusted to adapt to the new environment.

As specified in the schedule 22, a proper energy use unit is triggered at a designated time. Once an energy use unit is triggered, relevant sensor nodes 18 and one or more devices, such as one or more mobile devices, start to cooperatively execute a set of designated tasks for context monitoring, such as sensing, feature extraction, and context recognition.

In examples, the monitoring results are proactively forwarded to applications through callback functions.

One or more monitoring requests 12 can be received from any suitable, sensor or sensors, application or applications like fall detector, heartbeat monitor, place reminder, for example, depicted by 52.

FIG. 5 illustrates examples of device configurations 16 or energy units (EUs) for monitoring requests 12 of monitored contexts.

In the example of FIG. 5 the indication of ‘window’ is intended to indicate the window size of the raw input data for a single instance of context inference.

For example, in relation to accelerometer and gyroscope, in the example of FIG. 4, ‘window 128’ is intended to indicate that a stream of information from a sensor 30 is segmented into segments which have 128 samples of accelerometer and gyroscope, and perform one or more processes, such as energy computation, on the segments.

In relation to Blood Volume Pulse (BVP) and electrocardiography (ECG) sensors, in the example of FIG. 5, ‘window 6000’ is intended to indicate that 60-second long BVP/ECG sensor streams are taken as input.

In the illustrated example, ‘Trans.’ is intended to indicate transmission.

In part (a) of FIG. 5, a plurality of device configurations 16/EUs for “fall detection” (Q₀) are illustrated.

In part (b) of FIG. 5, a plurality of device configurations 16/EUs for “heartbeat monitor” (Q₁) are shown.

In part (a) of the example of FIG. 5, three device configurations 16/EUs are illustrated: EU_{0,0}, EU_{0,2}, and EU_{0,1}.

The device configurations 16 illustrated in the example of FIG. 5 also show the associated devices 18 and sensors 30.

In the illustrated example, a device configuration 16/EU illustrates a plurality of device actions 14 or sets of tasks (TSet) to be executed.

In the illustrated example, the device actions 14 comprise sensing actions 26 and processing actions 28.

In part (a) of the example of FIG. 5, the device configuration 16/EU_{0,0} comprises device actions 14 on a smart-hat 18 and smart-trousers 18.

Device configuration 16/EU_{0,1} comprises device actions 14 on a smart-watch 18.

Device configuration 16/EU_{0,2} comprises device actions 14 on smart-trousers and a smart-shirt.

Accordingly, part (a) of FIG. 5 illustrates three alternative and interchangeable device configurations 16 for fulfilling a fall detection monitoring request 12.

Similarly, in part (b) of FIG. 5 a configuration 16/EU_{1,0} is shown for a heartbeat monitor comprising device actions 14 on a smart-watch.

In part (b) of FIG. 5 a device configuration 16/EU_{1,1} for the heartbeat monitor comprises device actions 14 on a smart-shirt.

Accordingly, FIG. 5 illustrates alternative device configurations 16/EUs configured to perform fall detection and heartbeat monitoring.

In examples, the energy requirements for the various device configurations 16 of FIG. 5, and the energy resources of the various devices 18, can be determined and an appropriate schedule of device configuration usage 22 derived. See, for example, FIG. 6.

FIG. 6 illustrates an example of resource control. The example of FIG. 6 illustrates an example of energy control.

The example of FIG. 6 can, in examples, be considered an example of use of a method 100 of FIG. 1 and/or a method 200 of FIG. 2 and/or a method 400 of FIG. 4.

The example of FIG. 6 illustrates use of an inventive method described herein for a relatively simply case of two monitoring requests 12, in particular heart monitoring and fall detector.

In the left portion of FIG. 6, an example is shown without the inventive method described herein.

In FIG. 6, the available devices 18 are a shirt and a watch comprising sensors 30. In the example, the watch is equipped with an accelerometer and a SpO2 sensor and the shirt is equipped with a three-lead ECG sensor.

In the example on the left portion of FIG. 6 the sensors of the watch are used to perform both the heart monitoring and fall detector requests and the ECG sensor 30 in the shirt is not, initially, used.

It can be seen in the example in the left portion of FIG. 6 that the three axis accelerometer, of the watch, consumes 62 joules per hour and the BDP sensor consumes 169 joules per hour.

In the example of the left portion of FIG. 6 the remaining energy resource (device resource 24) is 1200 joules.

Accordingly, given the device resource usage rate 20 of the watch, the heart monitor and fall detector can run for approximately 5.2 hours before the energy of the watch is depleted.

However, after the energy of the watch is depleted, the ECG sensor on the shirt can be used to perform heart monitoring.

Accordingly, as the shirt has 800 joules remaining and the ECG sensor of the shirt consumes 120 joules per hour the heart monitor can run for a further 6.7 hours (11.9 hours in total) before the energy resource of the shirt is also depleted.

Accordingly, it can be seen that without the inventive method described herein the fall detector becomes inoperative after 5.2 hours, whereas the heart monitor continues for 11.9 hours.

This could be dangerous for a user who, for example, may fall after the fall detector functionality has failed.

However, the same device set-up is illustrated in the right portion of FIG. 6 using an inventive method described herein.

In the right portion of the example of FIG. 6, the ECG sensor 30 of the shirt is initially used to fulfill the heart monitor request 12 and the three axis accelerometer of the watch is used to fulfill the fall detector request 12.

Given the device resource usage rate 20 and device resources 24 of the shirt and watch the heart monitor and fall detector can run with these device configurations 16 for 6.7 hours before the resources of the shirt are depleted.

At this point, the watch has 785 joules remaining and therefore the BVP sensor 30 of the watch can be used to fulfill the heart monitor request 12 and the three axis accelerometer of the watch can be used to fulfill the fall detector request 12.

Accordingly, both requests can continue to be fulfilled for a further 3.4 hours before the resources of the watch are depleted.

Therefore, in the example to the right of FIG. 6 the heart monitor and fall detector can both run for 10.1 hours meaning that the fall detector can run for approximately double the time with only a slight reduction in the length of running time for the heart monitor.

This simple example shows the clear technical benefits of the inventive method described herein.

FIG. 7 illustrates an example of determining a schedule of device configuration usage 22.

In examples, any suitable method can be used to determine a schedule of device configuration usage 22. For example, a full analysis of all available arrangements of all available device configurations 16 can be performed to determine a schedule of device configuration usage 22 given one or more goals and/or limitations.

However, in such examples, determining a schedule of device configuration usage 22 can be processing intensive.

In examples, it can be beneficial to use a less processing intense method to determine a schedule of device configuration usage 22.

In some examples, this can be achieved by determining a schedule of device configuration usage 22 based, at least in part, on a degree of competition for available devices 18 and/or sensors 30 of the available devices 18.

For example, any suitable method that forces a query/request 12 with diverse device configuration 16/EU options and abundant energy resource to yield competitive resources to other queries/requests 12 with fewer device configuration 16/EU options and scarce energy resources can be used.

In examples, by making and/or allowing the queries/requests 12 with scarce resources to occupy the competitive energy resources, the running time gap, for example, among the queries/requests 12 can be significantly narrowed.

In examples, a query/request 12 is allowed to use competitive resources only after it exhausts less competitive resources.

If a query/request 12 has alternatives with less competition, it would be allowed, in examples, to use competitive resources after a predetermined time period or may not be allowed at all.

Meanwhile, a query/request 12 with scarce and few options can use the competitive resources.

In examples, such scheduling can have an effect to balance the lifetime of device 18 and/or sensor nodes by avoiding concentrated use of a certain device 18 and/or sensor node.

In examples, such scheduling can be considered altruistic scheduling.

FIG. 7 shows an example of the effectiveness of such a method of determining a schedule of device configuration usage 22 through an example scenario.

As can be seen in part (c) of FIG. 7, in the example, query/request q₀ has abundant resources with three alternative EUs, whereas query/request q₂ has only a single available EU using device 18/sensor node s₂.

In the example, query/request q₁ has two alternative EUs and can use the resource of device 18/sensor node s₂ or s₃.

FIG. 7 (a) shows the balanced schedule of device configuration usage 22 (EUS) that is obtained, in this example, using altruistic scheduling. In this example, altruistic scheduling forces q₀ and q₁ yield the highly competitive resource s₂ for q₂.

In the example, queries/requests q₀ and q₁ are scheduled to use the resource of s₂ only after alternative EUs cannot be run using less competitive resources. By using most of the energy resource of s₂, query/request q₂ can maximize its running time even though it has a single energy use option.

Accordingly, the running time of all three queries can be well balanced.

As a comparison, FIG. 7 (b) shows an EUS in which all individual queries preferably use an EU that utilizes the sensors with enough energy. In this case, queries/requests q₀ and q₁ first select EUs utilizing s₂ that has the most amount of energy, that is, 1000 J (see FIG. 7 (d)).

In this example, query/request q₂ shares the energy of s₂ with q₀ and q₁, and consequently, the running time of request q₂ is significantly reduced. In this example, the running time of q₂ becomes 2.8 times shorter than that of q₀, which indicates the significant unbalance in running times.

FIG. 8 illustrates an example of determining a schedule of device configuration usage 22.

In examples, an altruistic method of determining a schedule of device configuration usage 22 builds an schedule of device configuration usage 22 (EUS) through three steps: calculating degree of competition (DoC) for the device configurations 16/EU, sequencing available EUs in an altruistic way based on DoC, and calculating an execution time for the EUs.

FIG. 8 shows an example of the overall process of an altruistic scheduling algorithm. DoC computation. As a metric, the degree of competition (DOC) for an EU is defined. In examples, the DoC of an EU is determined by the potential competition of sensor nodes 30 used by the EU, which is denoted as a sensor competition (SC).

In examples, DoC can be defined as a function of multiple SC values that the EU is associated with. The maximum of the SC values can be used to define DoC.

The SC of a sensor node can be defined in any suitable way.

A simple definition of SC is the number of queries/requests 12 that uses the sensor node 30. It is intuitive that, as more queries want to use a node, the competition of the node increases.

However, this definition can have, in examples, a limitation that it does not consider the heterogeneity in available energy of the one or more nodes 30 and energy demand of the one or more queries/requests 12.

In examples, the SC of a sensor node 30 can be defined as the expected energy demand divided by the remaining energy. In some examples, if a sensor node 30 is used is not used by any queries/requests 12 or is used by only a single query/request 12, that is |Qₖ| is 0 or 1, it is considered that there is no competition.

$$SC of {s}_{k} = \{ \begin{matrix}\frac{{\sum }_{i , j} {d}_{k}^{i , j}}{{r}_{k}} , & if \vert {Q}_{k} \vert > 1 \\ 0 , & otherwise\end{matrix} , \\ where {Q}_{k} = \{ {q}_{i} \vert there is an EU for {q}_{i} that uses {s}_{k} \}$$

where sₖ is a kth sensor node, dₖ^{i,j} is the energy demand from for a set of tasks executed on sₖ for EU_{i,jv}, and rᵢᵥ is the remaining energy of sₖ.

Altruistic EU sequencing. In examples, a sequence of EUs is made for the query(ies)/request(s) 12 in an altruistic way. It can be done, for example, by sorting EUs in an increasing order of computed DoC values. In examples, the EU_{i,j}s for q₁ are arranged in EUSeq₁ in increasing order of the DoC value of EU_{i,j}s.

Computation of EU execution time. In examples, the execution time, t_{i,j} for every EU_{i,j} is determined to determine EUS.

The basic principle can be considered to be that an EU begins to be executed when all the alternative EUs with a smaller DoC cannot be run anymore. Also, an initiated EU ends only when the energy of any relevant nodes is exhausted.

The computation is incrementally conducted starting from the first EU in a EUSeq by estimating the energy drain of relevant sensor nodes.

In examples, let EU_{i,j} be j^{th} EU for query/request qᵢ in increasing order of DoC.

In examples, first, a set of the first EUs for the registered queries, {EU_{i,0}}, is retrieved and identified. Then, in examples, the time, tₘᵢₙ, when any sensor node 30 exhausts its battery for the first time is computed.

In examples, the time, tₘᵢₙ, is computed with the remaining energy of a sensor node 30 and the energy demand of the executed EUs.

Then, in examples, the remaining energy of a node and the execution time of the EUs after the time, tₘᵢₙ is updated.

Also, in examples, the EUs that have been utilizing the shutdown sensor node are switched to the next one, for example, from EU_{i,j} to EU_{i,j+1}.

In examples, the process is iterated until there are no available sensor nodes anymore.

According to analysis, the time complexity of the altruistic scheduling method is O(Ns*(Ns+Nq)), where Ns is the number of sensors and Nq is the number of queries.

Although the example of FIGS. 7 and 8 consider energy usage the constraint of other computing resources such as CPU, memory, and bandwidth can be considered.

In examples, the constraint of for example CPU, memory, bandwidth can be considered as 100%. Then, in examples, the scheduling decision can be made in a way that the sum of usages on a sensor node 30, for example, should be less than 100%.

For example, if there are 3 tasks and each task consumes 40% of CPU usage, we can avoid to assign three tasks on a single node (as the node cannot support 120% of CPU usage.)

In examples, CPU and memory usage rates, for example amount and/or time used, of one or more sensor applications can influence energy resource usage.

In examples resource demand profiling and monitoring methods can be utilized.

In examples, the constraint check is performed after the scheduling process, for example altruistic scheduling process. If a generated EUS cannot be executed due to resource constraint, the EUS is adjusted.

In examples, a victim with the longest expected running time is sacrificed. However, an altruistic scheduling method has an effect to avoid such resource contention by nature, since it avoids concentrated and competitive sensor utilization.

An example of pseudo code for altruistic scheduling is as follows:

| Function | : | ComputeExecutionTime |
|---|---|---|
| Input | : | QSet, SSet, |
| | | EUSet = {EU_{i,j} \| EU_{i,j}: the j^{th} EU for qᵢ in an |
| | | increasing order of DoC} |
| Output : | | EUS |

| | |
|---|---|
| 1. | Initialize rₖ ← GetEnergyAvailability(sₖ) for∀sₖ∈SSet |
| 2. | Initizlize t_{i,j} ← 0 for ∀EU_{i,j}∈EUSet // the execution time of EU_{i,j} |
| 3. | // EUSet_{c} : the set of EU's considered together at a certain time. |
| | They might concurrently run at a specific time. First, initialize |
| | it as the EU's executed at the start time. |
| 4. | Set EUSet_{c} to {EU_{i,0}} for ∀qᵢ∈Qset |
| 5. | // Until there is no available nodes anymore |
| 6. | while SSet ≠ ϕ |
| 7. | // Compute the expected lifetime of each sₖ |
| 8. | tₖ ← rₖ/GetEnergyDemand(sₖ, EUSet_{c}, 1) for each sₖ∈SSet |
| 9. | tₘᵢₙ ← min(tₖ) // compute the minimum lifetime |
| 10. | // Update the remaining energy of each sensor node after tₘᵢₙ |
| 11. | foreach sₖ ∈ SSet |
| 12. | rₖ ← rₖ − GetEnergyDemand{sₖ, EUSet_{c}, tₘᵢₙ) |
| 13. | if (rᵢ = 0) SSet ← SSet − {sᵢ} // remove shutdown sensors |
| 14. | // increment the duration of each current EU ‘s by tₘᵢₙ |
| 15. | t_{i,j} ← t_{i,j} + tₘᵢₙ for each EU_{i,j} ∈ EUSet_{c} |
| 16. | // update EUSet_{c} , i.e., the set of EU's currently considered |
| 17. | foreach EU_{i,j} in EUSet_{c} that have utilized a shutdown sensor |
| 18. | EUSet_{c} ← EUSet_{c}− {EU_{i,j}} |
| 19. | insert (EU_{i,j}, t_{i,j}) to EUSeqᵢ |
| 20. | if (there is EU_{i,j+1} in EUSet) |
| 21. | EUSet_{c} ← EUSet_{c} ∪ {EU_{i,j+1}} |
| 22. | else insert EUSeqᵢ to EUS |

In this example, line 1 shows the process of obtaining the remaining energy of sensor nodes where SSet is a set of available sensors and GetEnergyAvailability(Sₖ) is a function that returns the remaining energy of Sₖ.

At line 4, QSet is a set of registered queries and, at lines 8-9, GetEnergyDemand(S, EUSet_{c}, t) is a function that returns the estimated amount of energy consumed on a sensor sₖ for time t to execute a set of EUs.

Examples of the disclosure are advantageous. For example, enhanced control and/or management of resources, such as energy resources, are provided.

Additionally, or alternatively, in examples separate applications can simply register one or more requests without having to consider resource management and/or control.

Accordingly, application developers can be freed from low level resource, such as energy, management issues such as energy availability monitoring and demand profiling.

In examples, multiple alternative methods for a high level context can be used, exploiting, for example, different sensor combinations, sensing modalities, sample rate and network interfaces.

Additionally, or alternatively, examples of the disclosure can prevent irrevocable energy drains on one or more devices 18 and/or sensors 30 preventing certain desired user functionality.

FIG. 9A illustrates an example of an apparatus 10. The apparatus 10 may be a controller of an apparatus or device such as a mobile phone or sensor device.

Implementation of apparatus 10 may be as controller circuitry. The apparatus 10 may be implemented in hardware alone, have certain aspects in software including firmware alone or can be a combination of hardware and software (including firmware).

As illustrated in FIG. 9A the apparatus 10 may be implemented using instructions that enable hardware functionality, for example, by using executable instructions of a computer program 36 in a general-purpose or special-purpose processor 32 that may be stored on a computer readable storage medium (disk, memory etc) to be executed by such a processor 32.

The processor 32 is configured to read from and write to the memory 34. The processor 32 may also comprise an output interface via which data and/or commands are output by the processor 32 and an input interface via which data and/or commands are input to the processor 32.

The memory 34 stores a computer program 36 comprising computer program instructions (computer program code) that controls the operation of the apparatus 10 when loaded into the processor 32. The computer program instructions, of the computer program 36, provide the logic and routines that enables the apparatus to perform the methods illustrated in FIGS. 1 and/or 2 and/or 4. The processor 32 by reading the memory 34 is able to load and execute the computer program 36.

In examples, the apparatus 10 therefore comprises:
at least one processor 32; and
at least one memory 34 including computer program code
the at least one memory 34 and the computer program code configured to, with the at least one processor 32, cause the apparatus 10 at least to perform:
receiving one or more monitoring requests;
   determining one or more device actions to be performed to fulfill the received one or more monitoring requests;
   determining one or more device configurations for the one or more monitoring requests, wherein determining one or more device configurations comprises assigning the one or more determined device actions to one or more devices from a plurality of available devices;
   determining a device resource usage rate for the determined one or more device configurations; and
   determining a schedule of device configuration usage based, at least in part, on the determined device resource usage rate or rates and available device resources.

As illustrated in FIG. 9A, the computer program 36 may arrive at the apparatus 10 via any suitable delivery mechanism 54. The delivery mechanism 54 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 36. The delivery mechanism may be a signal configured to reliably transfer the computer program 36. The apparatus 10 may propagate or transmit the computer program 36 as a computer data signal.

Computer program instructions for causing an apparatus to perform at least the following or for performing at least the following:
receiving one or more monitoring requests;
   determining one or more device actions to be performed to fulfill the received one or more monitoring requests;
   determining one or more device configurations for the one or more monitoring requests, wherein determining one or more device configurations comprises assigning the one or more determined device actions to one or more devices from a plurality of available devices;
   determining a device resource usage rate for the determined one or more device configurations; and
   determining a schedule of device configuration usage based, at least in part, on the determined device resource usage rate or rates and available device resources.

The computer program instructions may be comprised in a computer program, a non-transitory computer readable medium, a computer program product, a machine readable medium. In some but not necessarily all examples, the computer program instructions may be distributed over more than one computer program.

Although the memory 34 is illustrated as a single component/circuitry it may be implemented as one or more separate components/circuitry some or all of which may be integrated/removable and/or may provide permanent/semi-permanent/dynamic/cached storage.

In examples the memory 34 comprises a random access memory 56 and a read only memory 58. In examples the computer program 36 can be stored in the read only memory 58. See, for example, FIG. 9B

In some examples the memory 34 can be split into random access memory 56 and read only memory 58.

Although the processor 32 is illustrated as a single component/circuitry it may be implemented as one or more separate components/circuitry some or all of which may be integrated/removable. The processor 32 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 1 and/or 2 and/or 4 may represent steps in a method and/or sections of code in the computer program 36. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus 10 can, in examples, comprise means for:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate or rates and available device resources.

In examples, an apparatus 10 can comprise means for performing a method, or at least part of a method, as disclosed herein.

In some but not necessarily all examples, the apparatus 10 is configured to communicate data from the apparatus 10 with or without local storage of the data in a memory 34 at the apparatus 10 and with or without local processing of the data by circuitry or processors at the apparatus 10.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The apparatus 10 may be part of the Internet of Things forming part of a larger, distributed network.

The processing of the data, whether local or remote, may be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the apparatus 10 where it may produce an output sensible to the subject such as an audio output, visual output or haptic output.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context.

In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring, in the foregoing specification, to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-26. (canceled)

27. An apparatus comprising:
at least one processor; and
at least one memory including computer program code that, when executed by the at least one processor, cause the apparatus to at least:
receive one or more monitoring requests;
determine one or more device actions to be performed to fulfill the received one or more monitoring requests;
determine one or more device configurations for the one or more monitoring requests, wherein the determining of one or more device configurations further comprises; assign the one or more determined device actions to one or more devices from a plurality of available devices;
determine a device resource usage rate for the determined one or more device configurations; and
determine a schedule of device configuration usage based, at least in part, on the determined device resource usage rate or rates and available device resources.

28. An apparatus as claimed in claim 27, wherein the device resource usage rate comprises an energy usage rate and the available device resources comprises an amount of energy available to the devices of the one or more device configurations.

29. An apparatus as claimed in claim 27, wherein the receiving of the one or more monitoring requests further comprises; receive a plurality of monitoring requests.

30. An apparatus as claimed in claim 27, wherein the determining the one or more device actions further comprises; determine one or more sensing actions and/or determine one or more processing actions to be performed.

31. An apparatus as claimed in claim 27, wherein the determining of the one or more device configurations further comprises; determine one or more available sensors configured for use in fulfilling the one or more monitoring requests.

32. An apparatus as claimed in claim 27, wherein the determining of the schedule of the device configuration usage further comprises at least one of:
optimize use of available device resources;
balance running times for the received at least one monitoring request; and
prioritize a running time of at least one received monitoring request.

33. An apparatus as claimed in claim 27, wherein the at least one memory further comprises computer program code that, when executed by the at least one processor, cause the apparatus to at least:
control one or more device of a device configuration to fulfill a received monitoring request at a scheduled time, based, at least in part, on the determined schedule of the device configuration usage.

34. An apparatus as claimed in claim 27, wherein the at least one memory further comprises computer program code that, when executed by the at least one processor, cause the apparatus to at least:
determine a change in the plurality of available devices; and
update the schedule of the device configuration usage based, at least in part, on the determined change in the plurality of available devices.

35. An apparatus as claimed in claim 34, wherein the change in the plurality of available devices comprises addition of at least one available sensor and/or removal of at least one available sensor.

36. An apparatus as claimed in claim 27, wherein the at least one memory further comprises computer program code that, when executed by the at least one processor, cause the apparatus to at least:
determine a change in the available device resources; and
update the schedule of the device configuration usage based, at least in part, on the determined change in the available device resources.

37. An apparatus as claimed in claim 36, wherein the change in the available device resources comprises at least one of the available devices being charged.

38. An apparatus as claimed in claim 27, wherein the schedule of the device configuration usage comprises a scheduled change from a first device configuration for a monitoring request to a second, different device configuration for the monitoring request.

39. An apparatus as claimed in claim 27, wherein the at least one memory further comprises computer program code that, when executed by the at least one processor, cause the apparatus to at least:
determine that at least one of the monitoring requests is removed; and
update the schedule of the device configuration usage based, at least in part, on the remaining monitoring request or requests.

40. An apparatus as claimed in claim 27, wherein the determining of the schedule of the device configuration usage further comprises; determine a degree of competition for available devices and/or sensors of the available devices for the determined device configurations; and determine the schedule of the device configuration usage based, at least in part, on the determined degree of the competition.

41. An apparatus as claimed in claim 40, wherein the determining of the degree of the competition for available devices and/or sensors of available devices further comprises; determine the number of device configurations that involve the available devices and/or the sensors of available devices, and determine the amount of the energy available to the available devices and/or sensors of available devices.

42. An apparatus as claimed in claim 27, wherein at least some of the plurality of available devices are interrelated and/or interdependent.

43. A method comprising:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate or rates and available device resources.

44. A method as claimed in claim 43, wherein the device resource usage rate comprises an energy usage rate and the available device resources comprises an amount of energy available to the devices of the one or more device configurations.

45. A method as claimed in claim 43, wherein receiving one or more monitoring requests further comprises receiving a plurality of monitoring requests.

46. A non-transitory computer readable medium comprising program instructions that, when executed by an apparatus, cause the apparatus to perform at least the following:
receiving one or more monitoring requests;
determining one or more device actions to be performed to fulfill the received one or more monitoring requests;
determining one or more device configurations for the one or more monitoring requests, wherein determining one or more device configurations comprises assigning the one or more determined device actions to one or more devices from a plurality of available devices;
determining a device resource usage rate for the determined one or more device configurations; and
determining a schedule of device configuration usage based, at least in part, on the determined device resource usage rate and available device resources.
